(19) United States
(12) Patent Application Publication
(10) Pub. No.: US 2005/0280609 A1
(43) Pub. Date: Dec. 22, 2005

(54) Plasma display apparatus and driving method of the same

(75) Inventors: Byung Soo Song, Goyang-si (KR); Jung Hwan Kim, Seoul (KR); Hee Chan Yang, Suyeong-gu (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/141,688

(22) Filed: Jun. 1, 2005

(30) Foreign Application Priority Data
Jun. 3, 2004 (KR) 10-2004-0040187

(51) Int. Cl. G09G 3/28

(52) U.S. Cl. 345/63

(57) ABSTRACT

An apparatus for driving a plasma display panel (PDP) and a method of driving the same are provided. The apparatus for driving the PDP includes a data determining part for analyzing image data input from the outside to count the number of turned on cells and for checking the turn on and off states of cells of a predetermined region of a screen, a data comparing part for comparing the number of turned on cells with a reference value to determine that it is a peak window pattern when the number of turned on cells is smaller than the reference value, and an operation controlling part for controlling an electrode driving part when a signal indicating that the number of turned on cells is smaller than the number of reference cells is received from the data comparing part to reduce time at which a sustain pulse rises.

This nonprovisional application claims priority under 35 U.S.C. § 119(a) on Patent Application No. 2004-10-0040187 filed in Republic of Korea on Jun. 3, 2004, the entire contents of which are hereby incorporated by reference.

### BACKGROUND OF THE INVENTION

1. Field of the Invention

The present invention relates to an apparatus and method for driving a plasma display panel capable of improving contrast and a method thereof.

2. Description of the Background Art

In general, a plasma display apparatus includes a plasma display panel (PDP) in which a partition wall formed between a top surface substrate and a bottom surface substrate forms a unit cell. A main discharge gas such as Ne, He, and Ne+He and an inactive gas including a small amount of xenon are filled in each cell. When discharge is generated by a high frequency voltage, the inactive gas generates vacuum ultraviolet (UV) rays and emits light from a fluorescent body formed between the partition walls to realize an image. Since the plasma display apparatus can be made thin and light, the plasma display apparatus is spotlighted as a next generation display apparatus.

FIG. 1 illustrates the structure of a common AC surface discharge type PDP.

As illustrated in FIG. 1, the common AC surface discharge type PDP includes a top surface substrate 122 and a bottom surface substrate 124 that run parallel to each other to face each other by a predetermined distance and that are made of transparent glass. At this time, partition walls 126 run parallel to each other on the bottom surface substrate in order to maintain the distance between the top surface substrate 122 and the bottom surface substrate 124.

Also, X electrode columns Xj (j=1, 2, . . . , and m) that are electric conductors are formed between the adjacent partition walls 126 to run parallel to the partition walls 126 in order to perform addressing function. R, G, and B fluorescent films of predetermined thickness cover the respective X electrodes to form light emitting layers 136.

On the other hand, Y and Z electrode rows Yi and Zi (I=1, 2, . . . , and n) are formed on the top surface substrate 122 that face the bottom surface substrate 124 to be perpendicular to the X electrodes. The Y and Z electrodes are extended to run parallel to each other by depositing indium tin oxide (ITO) and the electrode rows Yi and Zi that are adjacent to each other form pairs of electrode rows Yi and Zi.

Also, bus electrodes αi and βi that are made of metal to be narrower than the electrode rows Yi and Zi are formed to be attached to the electrode rows Yi and Zi. The bus electrodes αi and βi that are auxiliary electrodes are for compensating for the electrode rows Yi and Zi that lack conductivity. Therefore, it is possible to perform the function of the electrode rows Yi and Zi only by the bus electrodes αi and βi without forming transparent electrodes made of ITO.

A dielectric layer 130 is formed in order to protect the electrode rows Yi and Zi. An MgO layer 132 made of MgO is formed to contact the dielectric layer 130 in order to generate secondary electrons and to protect the electrode rows Yi and Zi.

After the respective electrodes Xj, Yi, Zi, αi, and βi, the dielectric layer 130, and the light emitting layers 136 are formed, the top surface substrate 122 and the bottom surface substrate 124 are sealed up and a discharge space 128 is exhausted and then, the moisture on the surface of the MgO layer 132 is removed by performing baking. Then, an inactive mixed gas of 400 to 600 torr including Ne—Xe gas by 3 to 7% is implanted into the discharge space 128.

A unit light emitting region is defined as a pixel cell P ₍ᵢⱼ₎ based on each of the intersections between the electrodes Yi and Zi and the electrodes Xj. When a wall charge is formed by addressing discharge between the electrodes Xj and the electrodes Yi, sustain pulses are applied between the electrodes Yi and Zi to maintain discharge in the pixel cell P ₍ᵢⱼ₎ so that the fluorescent bodies 136 are exited to emit light. When a voltage is applied between the electrodes Xj, Yi, and Zi, the light emitting discharge of the pixel cell P ᵢⱼ₎ is selected, maintained, and erased so that light emission is controlled.

A common PDP having the above-described structure is driven by applying proper pulses in a reset period, an addressing period, and a sustain period. That is, in the reset period, ramp-up pulses and ramp-down pulses are applied to uniformly form wall charges in the entire cells. In the addressing period, scan pulses are applied to the Y electrodes and data pulses are applied to the X electrodes so that cells to be turned on are selected. In the sustain period, sustain pulses are altemately applied to the Y electrodes and the Z electrodes so that discharge is maintained in the cells selected in the addressing period.

As described above, free electrons and cations move in the discharge space at any time when the PDP is driven to be accumulated on the respective electrodes. In particular, since the weight of the cations is much larger than the weight of the free electrons, the movement of the cations significantly affects the PDP.

In particular, the sputtering of the cations to the electrodes X deteriorates the fluorescent body formed in the electrodes X so that the amount of light of sustain discharge is reduced when peak brightness is measured to cause reduction in contrast Such a phenomenon becomes a significant problem when the PDP displays a peak window pattern.

### SUMMARY OF THE INVENTION

Accordingly, an object of the present invention is to solve at least the problems and disadvantages of the background art.

It is an object of the present invention to provide an apparatus for driving a plasma display panel (PDP) capable of preventing contrast from deteriorating due to reduction in brightness when images are displayed on the PDP and a method of driving the same.

An apparatus for driving the PDP according to the present invention includes a data determining part for analyzing image data input from the outside to count the number of turned on cells and for checking the turn on and off states of cells of a predetermined region of a screen, a data comparing part for comparing the number of turned on cells with a reference value to determine that it is a peak window pattern when the number of turned on cells is smaller than the reference value, and an operation controlling part for controlling an electrode driving part when a signal indicating that the number of turned on cells is smaller than the number of reference cells is received from the data comparing part to reduce time at which a sustain pulse rises.

A method of driving the apparatus for driving the PDP according to the present invention includes the steps of analyzing image data input from the outside to count the number of turned on cells, checking the turn on and off states of cells of a predetermined region of a screen, comparing the number of turned on cells with a reference value to determine that it is a peak window pattern when the number of turned cells is smaller than the reference value, and reducing time at which a sustain pulse applied by the electrode driving part when the number of turned on cells is smaller than the number of reference cells.

According to the present invention, when images are displayed on the PDP, in particular, when a peak window pattern is displayed on the PDP, it is possible to control the time at which the sustain pulse rises so that it is possible to prevent brightness from deteriorating. Therefore, it is possible to improve contrast.

### BRIEF DESCRIPTION OF THE DRAWINGS

The present invention will be described in detail with reference to the following drawings in which like numerals refer to like elements.

FIG. 1 illustrates the structure of a common AC surface discharge type plasma display panel (PDP).

FIG. 2 illustrates a peak window pattern according to an apparatus for driving a PDP of the present invention.

FIG. 3 is a block diagram illustrating the apparatus for driving the PDP according to the present invention.

FIG. 4 illustrates an electrode driving circuit in the apparatus for driving the PDP according to the present invention.

FIGS. 5A and 5B illustrate changes in a sustain pulse caused by the apparatus for driving the PDP according to the present invention in accordance with energy recovery (ER) time.

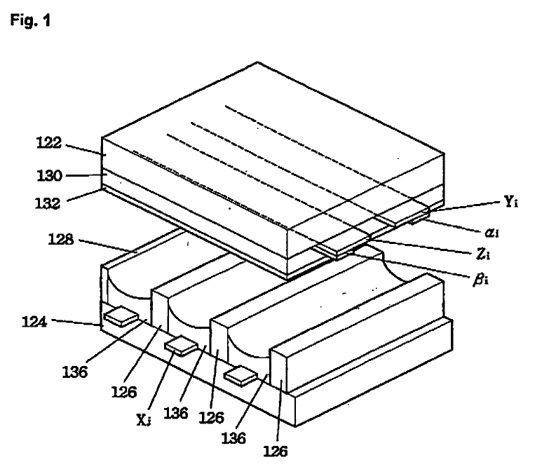

### DETAILED DESCRIPTION OF PREFERRED EMBODIMENTS

Preferred embodiments of the present invention will be described in a more detailed manner with reference to the drawings.

An apparatus for driving a plasma display panel (PDP) according to the present invention includes a data determining part for analyzing image data input from the outside to count the number of turned on cells and for checking the turn on and off states of cells of a predetermined region of a screen, a data comparing part for comparing the number of turned on cells with a reference value to determine that it is a peak window pattern when the number of turned on cells is smaller than the reference value, and an operation controlling part for controlling an electrode driving part when a signal indicating that the number of turned on cells is smaller than the number of reference cells is received from the data comparing part to reduce time at which a sustain pulse rises.

The data determining part counts the number of entire cells corresponding to the predetermined region.

The data determining part checks the turn on and off states of the cells of a predetermined number among the cells of the predetermined region and calculates difference in gray scales between the top and bottom lines to determine whether the difference in gray scales is no less than a predetermined reference value.

The predetermined region is the center of a screen.

The apparatus for driving a PDP further includes a timer for outputting a time information signal to the operation controlling part. The operation controlling part controls the electrode driving part only for predetermined time in accordance with the time information signal.

The predetermined time is equal to or larger than 5 seconds and equal to or smaller than 10 seconds.

The operation controlling part controls the electrode driving part so that a sustain voltage is applied before the potential of an electrode is maximal due to the LC resonance of the electrode driving part.

A method of driving a PDP according to the present invention includes the steps of analyzing image data input from the outside to count the number of turned on cells, checking the turn on and off states of cells of a predetermined region of a screen, comparing the number of turned on cells with a reference value to determine that it is a peak window pattern when the number of turned cells is smaller than the reference value, and reducing time at which a sustain pulse applied by the electrode driving part when the number of turned on cells is smaller than the number of reference cells.

The number of entire cells corresponding to the predetermined region is counted.

The method of driving a PDP further includes the step of calculating difference in gray scales between the top and bottom lines when the turn on and off states of the cells of a predetermined number among the cells of the predetermined region are checked to determine whether the difference in gray scales is no less than a predetermined reference value.

A sustain voltage is applied before the potential of an electrode is maximal due to the LC resonance of the electrode driving part.

Hereinafter, preferred embodiments of the present invention will be described in detail with reference to the attached drawings.

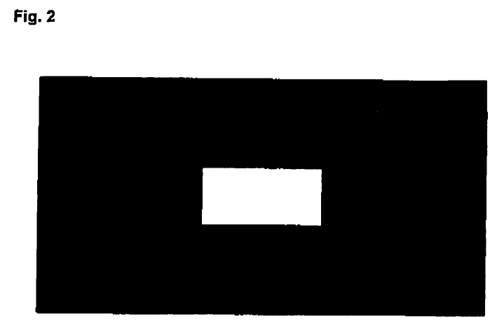

FIG. 2 illustrates the peak window pattern according to the apparatus for driving the PDP of the present invention.

As illustrated in FIG. 2, the peak window pattern displayed on the PDP is a pattern for measuring brightness when the largest gray scale in a certain region is displayed. The peak window pattern is comprised of the white region that is the cell region whose gray scale is largest and the black region that is the cell region whose gray scale is 0. At this time, the peak window pattern may be positioned in the center of a screen and may be positioned in the circumference of the screen not in the center of the screen.

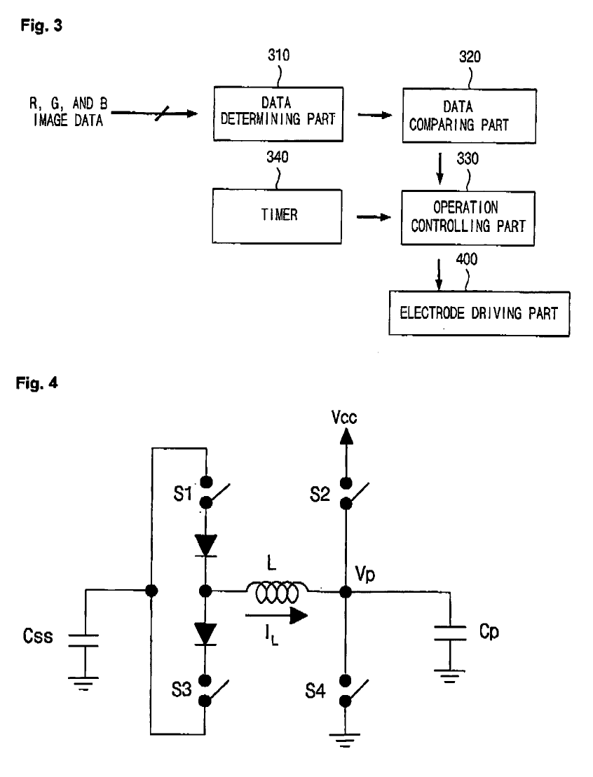

FIG. 3 is a block diagram illustrating the apparatus for driving the PDP according to the present invention. As illustrated in FIG. 3, the apparatus for driving the PDP includes a data determining part 310, a data comparing part 320, an operation controlling part 330, and a timer 340.

<Data Determining Part>

The data determining part 310 analyzes input R, G, and B image data to count the number of turned on cells, checks the turn on and off states of cells of a predetermined number among the cells in the center of a screen, and calculates difference in gray scales between top and bottom lines to determine whether the difference in gray scales is no less than a certain reference value.

That is, the data determining part 310 determines whether the input image data is the peak window pattern. The data determining part 310 must determine the number of turned on cells corresponding to the white region of FIG. 2 and the positions of the cells in order to determine whether the input image data is the peak window pattern.

Therefore, the data determining part 310 counts the number of turned on cells and determines the turn on and off states of the cells of the predetermined number among the cells of the center of the screen. At this time, the data determining part 310 does not determine the turn on and off states of all of the cells included in the center of the screen but the turn on and off states of some of the cells included in the center of the screen in order to reduce the amount of calculation of a process of determining data.

As described above, since the data determining part 310 determine the turn on and off states of some of the cells included in the center of the screen, difference in gray scales between the cell included in a line and the cell included in the next line is determined.

For example, difference in gray scales between the mth cell in a first line and the mth cell in a second (1+1) line is determined. The data determining part 310 performs such a process with respect to all of the cells in the first line to completely determine the peak window pattern.

At this time, if the data determining part 310 determines the turn on and off states of all of the cells included in the center of the screen, it is not necessary to determine difference in gray scales between the top and bottom lines.

<Data Comparing Part>

The data comparing part 320 compares the number of turned on cells with a reference value to determine which is larger between the number of turned on cells and the number of reference cells and determines that it is the peak window pattern when the number of turned on cells is smaller than the number of reference cells.

<Operation Controlling Part>

When a signal indicating that the number of turned on cells is smaller than the number of reference cells is received from the data comparing part 320, the operation controlling part 330 controls an electrode driving part 400 for a predetermined time to reduce the time at which the sustain pulse rises, that is, energy recovery (ER) time so that strong discharge occurs.

<Timer>

The timer 340 outputs a time information signal corresponding to predetermined time to the operation controlling part 330 in accordance with the peak window pattern determined by the data comparing part 320.

FIG. 4 is a circuit diagram of the electrode driving part 400 controlled by the operation controlling part according to the present invention.

The electrode driving part 400 illustrated in FIG. 4 is driven in four steps in accordance with the control of the operation controlling part 330.

In the first step, a first switch S1 included in a sustain circuit for the electrodes Y is turned on and second to fourth switches S2, S3, and S4 are turned off by the control signal of the operation controlling part 330. Therefore, the energy stored in a capacitor C_{SS} is supplied to a capacitor C_{P} by LC resonance so that the sustain pulse (hereinafter, V_{P}) applied to the electrodes Y rises At this time, the capacitor C_{P} is capacitance generated by the discharge cells of the PDP.

Next, in the second step, the second switch S2 is turned on and the first, third, and fourth switches S1, S3, and S4 are turned off by the control signal of the operation controlling part 330. At this time, the operation controlling part does not turn on the second switch S2 at the point of time where the potential of the sustain pulse V_{P} becomes V_{CC} due to the LC resonance but turns on the second switch S2 before the point of time where the potential of the sustain pulse V_{P} becomes V_{CC} in order to reduce the ER time.

Therefore, the sustain voltage V_{CC} is applied to the electrodes Y or the electrodes Z in a process where a voltage increases due to the LC resonance so that the ER time is reduced and that strong discharge occurs due to reduction in the ER time.

Then, in the third step, the third switch S3 is turned on and the first, second, and fourth switches S1, S2, and S4 are turned off. Therefore, the energy stored in the capacitor C_{P} is discharged to a capacitor C_{S}, so that the energy is collected and that the sustain pulse V_{P} falls.

Finally, in the fourth step, the fourth switch S4 is turned on and the first second, and third switches S1, S2, and S3 are turned off. Therefore, the sustain pulse V_{P} is in a ground level.

As described above, when the data determining part 310 and the data comparing part 320 determine that the input data is the peak window pattern, the operation controlling part 330 turns on the second switch S2 before the potential of the sustain pulse V_{P} becomes VCC due to the LC resonance to reduce the ER time. As described above, the ER time is reduced so that strong discharge occurs and that the brightness in the peak window pattern increases.

Also, the operation controlling part 330 controls the electrode driving part 400 in accordance with the reduced ER time for 5 to 10 seconds in accordance with the time signal of the timer 340 so that the electrode driving part 400 is driven without strain. That is, during several frames where images are displayed, the operation controlling part 330 applies the sustain pulse whose ER time is reduced to the electrode driving part 400 in the sustain period.

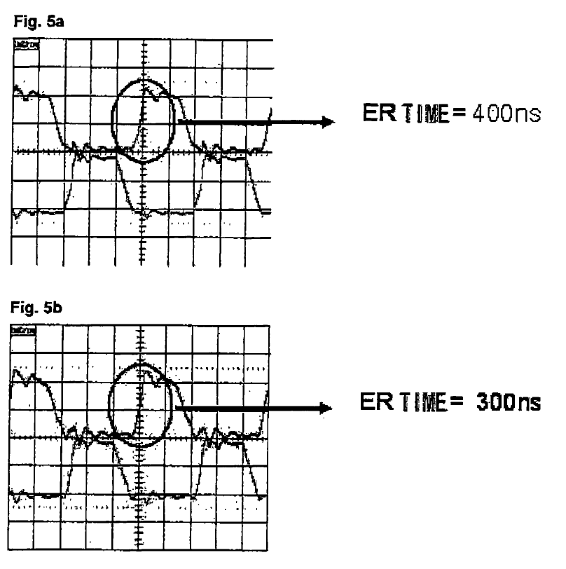

FIGS. 5A and 5B illustrate changes in a sustain pulse caused by the apparatus for driving the PDP according to the present invention in accordance with the ER time. That is, FIG. 5A illustrates a sustain pulse whose ER time is 400 ns and FIG. 5B illustrates a sustain pulse whose ER time is 300 ns. Referring to FIGS. 5A and 5B, the sustain pulse whose ER time is short of FIG. 5B has a larger peaking pulse than the sustain pulse whose ER time is long of FIG. 5A. Such peaking pulse causes strong discharge to compensate for the reduced amount of light, that is, reduced brightness and to thus improve contrast.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for driving a plasma display panel, the apparatus comprising:
a data determining part for analyzing image data input from the outside to count the number of turn-on cells and for checking the turn-on and off states of cells of a predetermined region of a screen;
a data comparing part for comparing the number of turn on cells with a reference value to determine that it is a peak window pattern when the number of turn-on cells is smaller than the reference value; and
an operation controlling part for controlling an electrode driving part when a signal which indicates that the number of turn-on cells is smaller than the number of reference cells is received from the data comparing part to reduce a sustain pulse rising time.

2. The apparatus as claimed in claim 1, wherein the data determining part counts the number of entire cells corresponding to the predetermined region.

3. The apparatus as claimed in claim 1, wherein the data determining part checks the turn on and off states of the cells of a predetermined number among the cells of the predetermined region and calculates difference in gray scales between the top and bottom lines to determine whether the difference in gray scales is no less than a predetermined reference value.

4. The apparatus as claimed in claim 1, wherein the predetermined region is the center of a screen.

5. The apparatus as claimed in claim 1, further comprising a timer for outputting a time information signal to the operation controlling part,
wherein the operation controlling part controls the electrode driving part only for predetermined time in accordance with the time information signal.

6. The apparatus as claimed in claim 5, wherein the predetermined time is equal to or larger than 5 seconds and equal to or smaller than 10 seconds.

7. The apparatus as claimed in claim 1, wherein the operation controlling part controls the electrode driving part so that a sustain voltage is applied before the potential of an electrode becomes maximal due to an LC resonance of the electrode driving part.

8. A method of driving a plasma display panel, the method comprising the steps of:
counting the number of turn-on cells by analyzing image data input from the outside;
checking the turn on and off states of cells of a predetermined region of a screen;
defining a peak window pattern when the number of turn-on cells is smaller than the reference value by comparing the number of turn-on cells with a reference value; and
reducing the rising time of a sustain pulse applied by the electrode driving part when the number of turn-on cells is smaller than the number of reference cells.

9. The method as claimed in claim 8, wherein the number of entire cells corresponding to the predetermined region is counted.

10. The method as claimed in claim 8, further comprising the step of determining whether the difference in gray scales is no less than a predetermined reference value by calculating difference in gray scales between the top and bottom lines, when the turn on and off states of the cells of a predetermined number among the cells of the predetermined region are checked.

11. The method as claimed in claim 8, wherein a sustain voltage is applied before the potential of an electrode becomes maximal due to an LC resonance of the electrode driving part.
